(19) United States
(12) Patent Application Publication
(10) Pub. No.: US 2004/0037257 A1
(43) Pub. Date: Feb. 26, 2004

(54) Method and apparatus for assuring quality of service in wireless local area networks

(75) Inventor: Chiu Y. Ngo, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/227,318

(22) Filed: Aug. 23, 2002

(51) Int. Cl. H04Q 7/24; H04J 3/16

(52) U.S. Cl. 370/338; 370/468

(57) ABSTRACT

A method and apparatus is described for maintaining quality of service (QoS) between a central controller and a set of mobile terminals (MTs) located within the coverage area of a basic service set (BSS) in a wireless local area network (WLAN). Upon a detection of a connection request by an MT and determining if adequate resources are available, establishing a connection with the MT using the most robust physical layer (PHY) mode with a sufficiently large set of packets to fulfill throughput requirements, if adequate resources are available and additional resources can be allocated. If adequate resources are not available, then attempting to allocate additional resources. In addition, a method is described for providing reliable transmission for a critical packet in a connection, including the steps of transmitting the critical packet at a first PHY mode; determining if adequate resources in the connection are available; and, transmitting a duplicate packet on a second PHY mode if adequate resources are available.

### BACKGROUND OF THE INVENTION

1. Field of the Invention

The present invention relates to communication systems. More particularly, the present invention relates to a method and apparatus for assuring quality of service in wireless local area networks.

2. Description of Related Art

Currently, both the Institute of Electrical and Electronics Engineers (IEEE) and the European Telecommunications Standards Institute (ETSI) have promulgated standards for wireless local area networks (WLAN). The WLAN standard supported by the ETSI is from the Broadband Radio Access Networks (BRAN) project and is contained in the HIgh PErformance Radio Local Area Network Type 2 (HIPERLAN2) specifications, available at the institute's world-wide-web site at http://www.etsi.org/. The WLAN standard proposed by IEEE is contained in the IEEE 802.11 series of standards, available from the institute's world-wide-web site at http://www.ieee.org/.

In general, there are two variants of WLANs: the infrastructure-based type and the ad-hoc type. In the former type of network, communication typically takes place only between the wireless nodes, called Mobile Terminals (MT) or stations, and an Access Point (AP). An AP is a device that is responsible for the centralized control of the resources in a radio cell and is generally connected to a fixed (i.e., not wireless) network. In the ad-hoc type of network, communication takes place between the wireless nodes, with one of the MTs, referred to as a Central Controller (CC), providing control functionality equivalent to that of an AP. The MTs and the AP/CC, which are within the same radio coverage area, are known as a Basic Service Set (BSS).

One of the features of both the IEEE 802.11a and ETSI/BRAN HIPERLAN2 standards is the availability of different physical transmission modes between AP/CC and MTs—achieved through various combinations of coding and modulation schemes. These physical transmission modes are referred to as PHY modes. In 802.11a and HIPERLAN2, there are eight and seven PHY modes, respectively. Currently, each MT operates on a PHY mode that is optimal for that MT, with the AP/CC supporting each MT on its respective PHY mode. By adopting different PHY modes, the AP/CC of a WLAN can handle different interference and propagation environments. This can help to maintain the Quality of Service (QoS) of a connection. Currently, the decision to switch from one PHY mode to another is usually based on the signal-to-noise ratio and/or the packet/bit error rate. Normally, switching is a one-step process (i.e., from one mode to the next higher/lower mode).

In addition, reliability is another important issue. In some real-time applications, the system does not have the luxury of retransmitting an error packet due to time constraints. Currently, reliability is achieved using another layer of forward error correction (FEC) code at the medium access control (MAC)/Data Link Control (DLC) to provide addition protection of such kind of real-time packet. This additional layer adds more complexity to the decoding process.

Thus, it would be preferable to provide other ways that can assure QoS and achieve reliability while maintaining the same throughput.

### SUMMARY OF THE INVENTION

The present invention is directed to a method and apparatus for assuring quality of service in wireless local area networks (WLANs) using link adaptation and scheduling.

According to an aspect of the present invention, a method for maintaining quality of service (QoS) between a central controller and a set of mobile terminals (MTs) located within the coverage area of a basic service set (BSS) in a wireless local area network (WLAN) is provided. The method includes the steps of detecting a connection request by an MT; determining if adequate resources are available; attempting to allocate additional resources, if adequate resources are not available; and, establishing a connection with the MT using the most robust physical layer (PHY) mode with a sufficiently large set of packets to fulfill throughput requirements, if one of adequate resources are available and additional resources can be allocated.

Another aspect of the present invention provides an apparatus for maintaining quality of service (QoS) between a central controller and a set of mobile terminals (MTs) located within the coverage area of a basic service set (BSS) in a wireless local area network (WLAN). The apparatus includes a receiver circuit; a transmitter circuit; a processor, coupled to the receiver circuit and the transmitter; and, a memory, coupled to the processor. The memory is configured to allow the processor to detect a connection request by an MT by the receiver circuit; determine if adequate resources are available; attempt to allocate additional resources, if adequate resources are not available; and, establish a connection with the MT using the most robust physical layer (PHY) mode with a sufficiently large set of packets to fulfill throughput requirements, if one of adequate resources are available and additional resources can be allocated.

Yet another aspect of the present invention provides another apparatus for maintaining quality of service (QoS) between a central controller and a set of mobile terminals (MTs) located within the coverage area of a basic service set (BSS) in a wireless local area network (WLAN). The apparatus includes means for detecting a connection request by an MT; means for determining if adequate resources are available; means for attempting to allocate additional resources, if adequate resources are not available; and, means for establishing a connection with the MT using the most robust physical layer (PHY) mode with a sufficiently large set of packets to fulfill throughput requirements, if one of adequate resources are available and additional resources can be allocated.

Still yet another aspect of the present invention provides a method for providing reliable transmission for a critical packet in a connection, including the steps of transmitting the critical packet at a first PHY mode; determining if adequate resources in the connection are available; and, transmitting a duplicate packet on a second PHY mode if adequate resources are available.

The foregoing and other features and advantages of the invention will be apparent from the following, more detailed description of preferred embodiments as illustrated in the accompanying drawings in which reference characters refer to the same parts throughout the various views.

### BRIEF DESCRIPTION OF THE DRAWINGS

FIG. 1 is a simplified block diagram illustrating the architecture of a wireless communication system whereto embodiments of the present invention are to be applied;

FIG. 2 illustrates the format of an HIPERLAN2 MAC frame that can be used to transmit information between stations according to an embodiment of the present invention;

FIG. 3 illustrates an exemplary HIPERLAN2 MAC frame, including a detail of the down link (DL) phase, that is transmitting information between stations according to an embodiment of the present invention;

FIG. 4 illustrates a second exemplary HIPERLAN2 MAC frame, including a detail of the down link (DL) phase, that is transmitting information between stations according to an embodiment of the present invention;

FIG. 5 is a flow chart illustrating the operation steps of providing Quality of Service (QoS) using link adaptation according to an embodiment of the present invention;

FIG. 6 is a flow chart illustrating the operation steps of providing QoS using duplicate transmission for critical packets according to an embodiment of the present invention.

FIG. 7 illustrates a simplified block diagram of an access point or central controller configured in accordance with an embodiment of the present invention.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details. In addition, it should be noted that although this invention uses HIPERLAN2 as an example for illustration, the invention itself can be applied to IEEE802.11a as well.

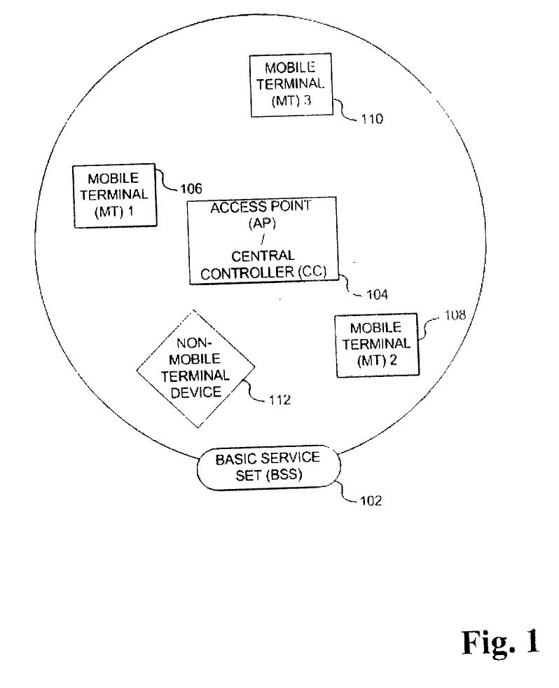

FIG. 1 illustrates a representative network whereto embodiments of the present invention are to be applied. As shown in FIG. 1, a basic service set (BSS) 102 contains an access point/central controller (AP/CC) 104 coupled to a plurality of mobile terminals, MT 106, MT 108 and MT 110. The MTs and AP/CC communicating with each other through a wireless link having a plurality of wireless channels. In addition, FIG. 1 also contains a non-MT device 112. Although non-MT device 112 is not a part of the BSS, it operates on the same frequencies of the AP/CC and MTs in the BSS and causes interference for the devices in the BSS. This creates a noisy environment and potentially has the ability to disrupt communications in the network. It should be noted that the network shown in FIG. 1 is small for purposes of illustration. In practice most networks would include a much larger number of mobile stations and non-MT devices.

The Physical Layer (PHY) defined in HIPERLAN2 includes a plurality of transmission rates based on different modulations and channel coding schemes so that the transmitter of a frame can choose one of the multiple data rates defined in the system based on the wireless channel condition between the receiver and itself at a particular time. Each device in a BSS uses the same channel, but each MT can communicate with the AP/CC using a different PHY mode. In addition, each device may also change the PHY mode in which it is transmitting by itself or upon request by the AP/CC. The different data rates, ranging from 6 to 54 Mbit/s, are achieved by using various signal alphabets for modulating the Orthogonal Frequency Division Multiplexing (OFDM) sub-carriers and by applying different puncturing patterns to a mother convolutional coding rate. This feature allows the system to improve the radio link quality by means of a link adaptation scheme to account for changing interference situations and distance considerations. Binary Phase Shift Keying (BPSK), Quaternary Phase Shift Keying (QPSK), 16-Quadrature Amplitude Modulation (QAM) are used as mandatory modulation formats, whereas 64QAM is optional. For illustration purpose, we use HIPERLAN2 as an example with its seven PHY modes shown in the following table.

TABLE 1
Different PHY Modes in HIPERLAN2

| | | Coding rate | Nominal bit rate |
|---|---|---|---|
| Mode | Modulation | R | [Mbit/s] |
| 1 | BPSK | 1/2 | 6 |
| 2 | BPSK | 3/4 | 9 |
| 3 | QPSK | 1/2 | 12 |
| 4 | QPSK | 3/4 | 18 |
| 5 | 16QAM | 9/16 | 27 |
| 6 | 16QAM | 3/4 | 36 |
| 7 | 64QAM | 3/4 | 54 |

Typically, the lower the transmission rate used, the more reliable the transmission. However, the lower transmission rate equates with lower bandwidth. Thus, by changing from a higher PHY mode to a lower one, one can improve the link quality (in terms of packet/bit error rate) but the system will not be able to sustain the throughput requirement of that connection.

Assurance of quality of service (QoS) under a vulnerable wireless communication environment is an important but difficult problem. A key principle of the present invention is to provide a mechanism to maintain the Quality of Service (QoS) of the links between each MT and the AP/CC. Specifically, throughput of a wireless connection is maintained in the present invention by using link adaptation and scheduling. Moreover, reliability of the wireless connection is increased by transmitting redundant data packets using different transmission rates.

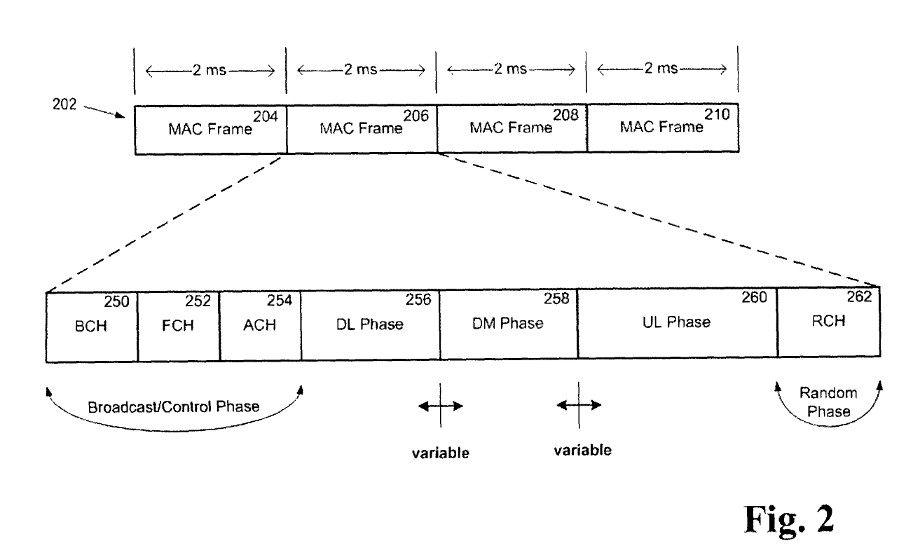

HIPERLAN2 also provides for a Medium Access Control (MAC) protocol that interfaces with the PHY layer. FIG. 2 is an exemplary set of MAC frames 202 containing MAC frames 204, 206, 208 and 210. All MAC frames in HIPERLAN2 are 2 milliseconds (ms) in length and have the same format. The general contents of all MAC frames are illustrated in MAC frame 206 and can contain the following five phases: a broadcast/control phase, a DownLink (DL) Phase 256, a Direct Mode/Direct Link (DM) Phase 258, an UpLink (UL) Phase 260, and a Random Phase.

The broadcast/control phase contains broadcast control information, including synchronization information, allocation of packets for each device, and control of which PHY mode each device should operate on. It includes a Broadcast CHannel (BCH) 250, which is a transport channel that carries the logical channel that broadcasts control information. The broadcast/control phase also includes a Frame CHannel (FCH) 252, which is a transport channel that carries the frame control channel, a logical channel that contains information defining how the resources are allocated in the current MAC frame, including the timing and PHY mode information as well as the number of packets assigned to each connection. In general, the content in the frame control channel changes dynamically from frame to frame. Lastly, the broadcast/control phase includes an Access feedback CHannel (ACH) 254, which is a transport channel for the random access feedback channel, a logical channel where the result of the access attempts to the random channel made by the MTs, also known as resource requests, in the previous MAC frame is conveyed. As further described below, MTs vie for access to the system using the Random Phase.

DownLink phase 256 is the part of the downlink transmission of a MAC frame during which user and control data is transmitted from the AP/CC “downlink” to the MTs. The data transmitted can be user as well as control data in unicast, broadcast and multicast modes. Direct Mode (DM) phase 258 is the period where data exchange can occur between MTs associated with the same AP or CC takes place without passing but under control of the access point or the central controller. Uplink (UL) phase 260 is the part of the MAC frame in which data is transmitted from MTs to an AP/CC. The Random Phase or, random access phase, is the period of the MAC frame where any MT can try to access the system. A contention scheme is applied to the access of the Random Phase to ensure fair access to the random channel by all MTs. The random phase contains a Random CHannel (RCH) 262, which is a transport channel in the uplink of the MAC frame that carries the following logical channels: random access channel and association control channel.

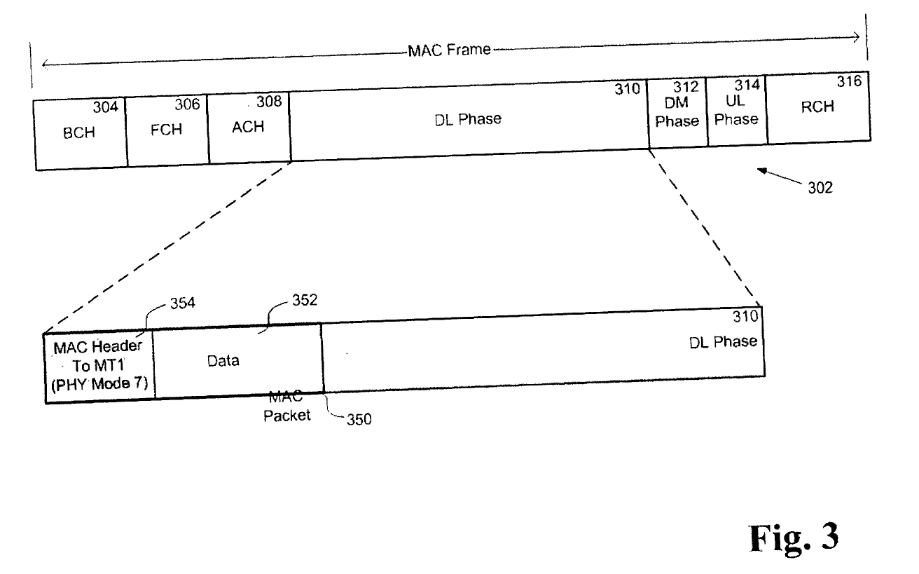

FIG. 3 is a block diagram of an exemplary MAC frame 302 including a DL phase 310. MAC frame 302 includes a MAC packet 350 contained in DL phase 310. The control information for MAC Packet 350, such as the timing and PHY mode information of the packet, has already been transmitted in the FCH phase. MAC packet 350 includes a MAC Header 354 and a Data portion 352. MAC packet 350 is being transmitted from AP/CC 104 to MT1 106 at PHY mode 7. In this example, the amount of data being transmitted from AP/CC 104 to MT1 106 requires that one packet per frame be transmitted (i.e., 54 Mbps). However, due to interference from a source of interference such as non-MT device 112, the transmission needs to be degraded to a lower PHY mode. In order to maintain throughput for a particular connection, the present invention increases the packet allocation per MAC frame for that connection. For example, for the connection transmitting at PHY mode 7 (i.e., 54 Mbps), the amount of data being transmitted requires that one packet be allocated per frame. However, if the transmission needs to be degraded to PHY mode 5 (i.e., 27 Mbps), two packets per frame would need to be allocated to this connection in order to maintain the same throughput as a connection under PHY mode 7.

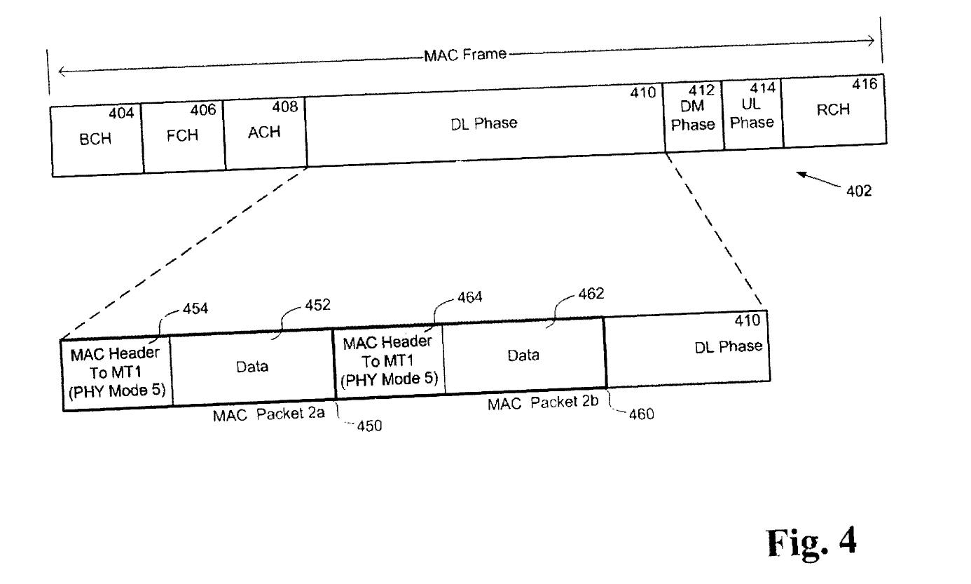

FIG. 4 is a block diagram of an exemplary MAC frame 402 including a DL phase 410. MAC frame 402 includes a first MAC packet 2a 450 and a second MAC packet 2b 460 contained in DL phase 410. The control information for first MAC packet 2a 450 and second MAC packet 2b 460, such as the timing and PHY mode information of the packets, has already been transmitted in the FCH phase. MAC packet 2a 450 includes a MAC Header 454 and a Data portion 452 while MAC packet 2b 460 includes a MAC Header 464 and a Data portion 462. MAC packet 2a 450 and MAC packet 2b 460 are being transmitted from AP/CC 104 to MT1 106 at PHY mode 5. In this fashion, the system can maintain the same throughput for the connection by transmitting a greater number of packets at a lower PHY mode.

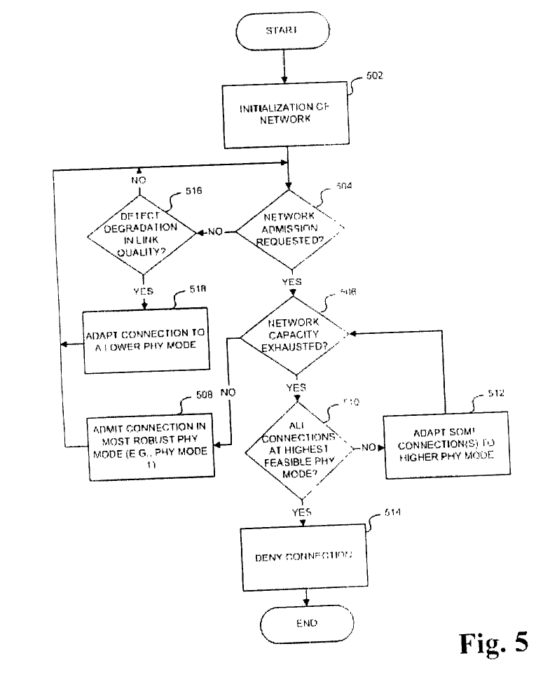

FIG. 5 is a flow diagram illustrating one possible method of operation of AP/CC 104 to implement the present invention. The method of operation includes the following steps: in step 502, AP/CC 104 is reset and the network is initialized. The initialization process is implementation specific and is well-known in the art. For example, AP/CC 104 determines which channel on which to communicate, and resets all allocations to begin listening to and accepting connection requests by MTs. In step 504, AP/CC 104 detects that an MT requests admission to the network. In this example, MT1 106 is the first MT that requests admission to the network. Once a network admission is detected, operation proceeds with step 506, where AP/CC 104 determines if network capacity is exhausted. As no MT's are currently on the network, no capacity is being used and thus operation goes to step 508. In step 508, AP/CC 104 admits a connection by MT1 106 in the most robust mode necessary to fulfill throughput requirements. In this example, AP/CC 104 establishes a connection with MT1 106 at PHY mode 1. In one embodiment, a connection is always established at the most robust PHY mode, PHY mode 1, and allowed to transmit the maximum number of packets necessary to satisfy throughput requirements of the application. If a higher amount of throughput is needed that is not capable of being met by the PHY mode 1, a higher PHY mode may be used. In another embodiment, the connection may be established at another PHY mode negotiated between AP/CC 104 and the MT. Alter the connection is established, AP/CC 104 then returns to normal operations.

If AP/CC 104 detects that network admissions is requested by an MT in step 504, but network capacity is exhausted in step 506, AP/CC 104 will determine if all connections are currently at the highest possible PHY mode in step 510. If all connections are not at the highest possible PHY mode, AP/CC 104 can reconfigure the network and possibly admit the MT. In one embodiment, AP/CC 104 will only admit connections until the network is approximately 80% full, with all connections at their highest possible PHY mode. In other embodiments, AP/CC 104 may increase or decrease the percentage based on implementations specific factors.

In step 512, AP/CC 104 adapts one or more connection to a higher PHY mode by communicating with the MT to allocate sufficient resources in an attempt to admit the new connection. In one embodiment, AP/CC 104 will first adapt all connections that are at the lowest PHY modes first and then adapt the connections that are at higher PHY modes. In another embodiment, AP/CC 104 will selectively adapt connections based on an assigned priority or other factors, such as the Received Signal Strength Indicator (RSSI) level.

If all connections are at their highest possible PHY mode, this means that the network is at maximum capacity and AP/CC 104 will refuse to admit any future MTs until one or more connections can be adapted to a higher PHY mode according to a link adaptation algorithm, or until one or more connections are terminated. In step 514, the network admission request is refused.

When AP/CC 104 does not detect network admission being requested in step 504, AP/CC 104 will check to see if there is degradation in link quality in step 516. If it is detected that the link quality in a connection such as the one with MT1 106 has degraded—either through interference from a device such as non-MT device 112 or from a change in location of the MT, then operation will continue with step 518. In step 518, AP/CC 104 adapts the connection to a lower PHY mode while maintaining the throughput by allocating an adequate number of packets. In one embodiment, the connection can be adapted to the next lower PHY mode. In another embodiment, the connection is switched to a lower PHY mode. In yet another embodiment, the connection can be switched to the lowest PHY mode, PHY mode 1 (6 Mbps). If additional radio resources (bandwidth) are available, there is no restriction to a single-step PHY mode adjustment. In the extreme case, consider a switch of the PHY mode to 1 (6 Mbps) from PHY mode 7. In this case, 9 packets/frame (9×6 Mpbs=54 Mbps) are necessary to maintain the throughput of the connection. Similar argument applies when switching from a lower PHY mode to a higher one. For example, if we have a connection of one packet/frame transmitted at 54 Mbps, we can adapt it to 9 packets/frame at 6 Mbps or 2 packets/frame at 27 Mbps etc., depending on the resource available. If there is no way to fall back to the lowest feasible PHY modes with adequate resource to maintain the throughput, re-negotiation of that connection will be needed. In addition, if the connection is already at the lowest PHY modem, it will stay at this mode until the retransmission count, if any, is exhausted. Then, no resource will be allocated to this connection until a resource request is received.

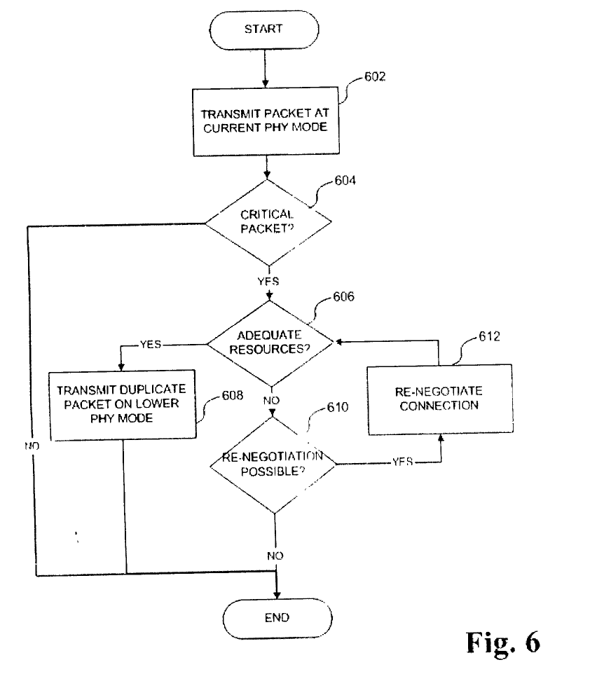

FIG. 6 is a flow diagram illustrating the operation of the system in accordance with one embodiment of the present invention increase reliability of transmission of packets for a connection which does not have the luxury of retransmission. The operation begins with step 602, where a packet is transmitted at the PHY mode under which the current connection is operating. Then, in step 604, it is determined whether the packet that was just transmitted is a critical packet—i.e., a packet that will become obsolete or useless if retransmission is needed. In one embodiment, a critical packet is any packet that is tagged by an application to be critical. If the packet is a critical packet, then operation continues with step 606, where AP/CC 104 determines if there are adequate resources available for transmission of a duplicated packet. If there are not enough resources, operation continues with step 610, where it is determined if re-negotiation of the connection is available. If renegotiation of the connection is possible, then the connection is renegotiated in step 612, and it is determined again in step 606 if adequate resources are available to transmit the duplicate packet. If so, the duplicate packet is transmitted in a lower PHY mode after the renegotiation of the connection is complete in step 608.

In cases where errors occur in transmissions, error packets are due to the lack of wireless link quality. In order to improve the reliability of a connection, the present invention provides additional redundancy to the transmission of packets of that connection. Since the physical layer of a wireless device is capable to switch from one PHY mode to another within a MAC frame, one can transmit the same packets multiple times at different PHY modes, provided radio resources are available. For example, if a packet is being transmitted at 54 Mbps, it can also be transmitted at another PHY mode, such as 27 Mbps. This is done only when there isn't the luxury of retransmission. Of course, there is a trade-off between overhead and reliability. However, the exact determination between use of bandwidth for overhead and reliability is implementation specific and can be dynamically changed.

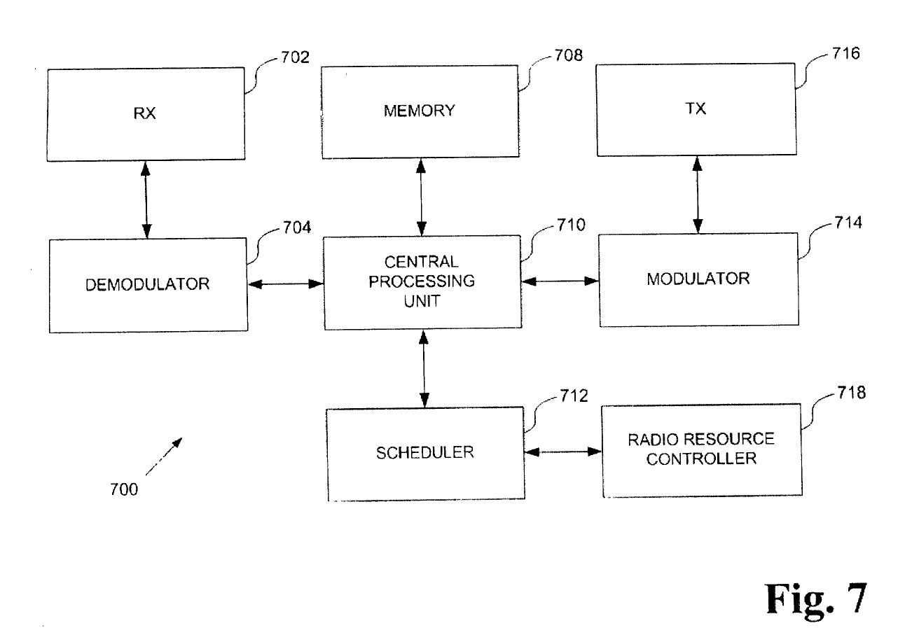

Referring to FIG. 7, AP/CC 104 may be configured as a system 700 with the architecture that is illustrated in the block diagram of FIG. 7. System 700 includes a receiver 702, a demodulator 704, a memory 708, a control processing unit (processor) 710, a scheduler 712, a modulator 714, a transmitter 716 and a radio resource controller 718. The exemplary system 700 of FIG. 7 is for descriptive purposes only. Although the description may refer to terms commonly used in describing particular access points or mobile stations, the description and concepts equally apply to other processing systems, including systems having architectures dissimilar to that shown in FIG. 7. In addition, various elements of the described architecture of system 700 may be applied to the architecture of each MT within BSS 102 of FIG. 1, although such elements as the scheduler 712 are typically only located in such devices as AP/CC 104.

In operation, the receiver 702 and the transmitter 716 are coupled to an antenna (not shown) to convert received signals and transmit desired data into corresponding digital data via the demodulator 704 and the modulator 714, respectively. The scheduler 712 operates under the control of the processor 710 to determine the composition of MAC frames in accordance with the HIPERLAN2 standard using the novel aspects of the present invention. In addition, the inputs to scheduler 712 may include information from radio resource controller 718, which performs such radio resource management functions as link adaptation, power control, admission control, congestion control, dynamic frequency selection, and handover initiation.

As previously described, various parts of the MAC frame are used to exchange control (signaling) information such as the frame composition in the FCH (AP/CC to MTs), feedback for the contention channel (AP/CC to MTs) and resource requests (MTs to AP/CC), through specific transport channels. This includes the allocation of resources for the transmission of user and control data in the UpLink, DownLink and Direct Link phases as well as the allocation of the appropriate number of Random Channels per MAC frame. It is assumed that the scheduler uses the information obtained from MTs through resource requests during the random phase and the status of its own downlink transmission buffers when composing a MAC frame. In addition, the scheduler 712 maintains transmission and reception processes that transmits and receives sequence of transport channels delivered to and received from the physical layer in accordance with the MAC frame defined by the scheduler 712, and maps logical channels onto transport channels. It is to be noted that one or more of the described functions of the scheduler 712 may be achieved by using program code stored in memory 708 and executed by processor 710. Memory 708 is coupled to the processor 710 and contains all program code and data necessary for operation of the system 700.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular disclosed embodiment as the best mode contemplated for carrying out the present invention, but that the present invention include all embodiments falling within the scope of the appended claims.

What is claimed is:

1. A method for maintaining quality of service (QoS) between a central controller and a set of mobile terminals (MTs) located within the coverage area of a basic service set (BSS) in a wireless local area network (WLAN), comprising the steps of:
detecting a connection request by an MT;
determining if adequate resources are available;
attempting to al locate additional resources, if adequate resources are not available; and,
establishing a connection with the MT using the most robust physical layer (PHY) mode with a sufficiently large set of packets to fulfill throughput requirements, if one of adequate resources are available and additional resources can be allocated.

2. The method of claim 1, further comprising the steps of:
determining if a link quality of any connection has degraded; and,
adapting all connections with degraded link quality.

3. The method of claim 1, wherein the step of determining if adequate resources are available comprises the step of: determining whether utilization of the BSS is below a capacity threshold.

4. The method of claim 1, wherein the step of allocating additional resources comprises the steps of:
determining if any connection are not adapted to a higher PHY mode; and,
adapting at least one connection to a higher PHY mode if there is at least one connection not at the higher feasible PHY mode.

5. The method of claim 4, wherein the step of adapting at least one connection to the higher PHY mode if there is at least one connection not at the higher PHY mode comprises the steps of:
determining a throughput requirement and a PHY mode of the connection not at the higher PHY mode;
increasing the connection to a new higher PHY mode; and,
allocating a sufficient number of packets to satisfy the throughput requirement for the connection.

6. The method of claim 5, where the PHY mode of the connection not at the higher PHY mode and the new PHY mode both have a corresponding transmission rate and wherein the step of allocating the sufficient number of packets comprises the steps of:
dividing, (i) the transmission rate of the PHY mode of the connection not at the higher PHY mode, by, (ii) the transmission rate of the new PHY mode, to create an adjustment ratio; and,
using the adjustment ratio to determine the sufficient number of packets.

7. The method of claim 2, wherein the step of adapting all connections with degraded link quality comprises the steps of:
determining a throughput requirement and a PHY mode of a connection with degraded link quality;
reducing the connection to a new lower PHY mode; and,
allocating a sufficient number of packets to satisfy the throughput requirement for the connection.

8. The method of claim 7, where the PHY mode of the connection with degraded link quality and the new lower PHY mode both have a corresponding transmission rate and wherein the step of allocating the sufficient number of packets comprises the steps of:
dividing, (i) the transmission rate of the PHY mode of the connection with degraded link quality, by, (ii) the transmission rate of the new PHY mode, to create an adjustment ratio; and,
using the adjustment ratio to determine the sufficient number of packets.

9. The method of claim 3, where the capacity threshold is within a range of 80 to 100 percent.

10. An apparatus for maintaining quality of service (QoS) between a central controller and a set of mobile terminals (MTs) located within the coverage area of a basic service set (BSS) in a wireless local area network (WLAN), comprising:
a receiver circuit;
a transmitter circuit;
a processor, coupled to the receiver circuit and the transmitter; and,
a memory, coupled to the processor, the memory being configured to allow the processor to:
detect a connection request by an MT by the receiver circuit;
determine if adequate resources are available;
attempt to allocate additional resources, if adequate resources are not available; and,
establish a connection with the MT using the most robust physical layer (PHY) mode with a sufficiently large set of packets to fulfill throughput requirements, if one of adequate resources are available and additional resources can be allocated.

11. The apparatus of claim 10, where the memory is further configured to allow the processor to:
determine if a link quality of any connection has degraded; and,
adapt all connections with degraded link quality.

12. The apparatus of claim 10, wherein to determine if adequate resources are available, the memory is further configured to allow the processor to: determine whether utilization of the BSS is below a capacity threshold.

13. The apparatus of claim 10, wherein to allocate additional resources, the memory is further configured to allow the processor to:
determine if any connection are not adapted to a higher PHY mode; and,
adapt at least one connection to the higher PHY mode if there is at least one connection not at the higher PHY mode.

14. The apparatus of claim 13, wherein to adapt at least one connection to the higher PHY mode if there is at least one connection not at the higher PHY mode, the memory is furthered configured to allow the processor to:
determine a throughput requirement and a PHY mode of the connection not at the higher PHY mode;
increase the connection to a new PHY mode; and,
allocate a sufficient number of packets to satisfy the throughput requirement for the connection.

15. The apparatus of claim 14, where the PHY mode of the connection not at the higher PHY mode and the new PHY mode both have a corresponding transmission rate and wherein to allocate the sufficient number of packets, the memory is further configured to allow the processor to:
divide, (i) the transmission rate of the PHY mode of the connection not at the higher PHY mode, by, (ii) the transmission rate of the new PHY mode, to create an adjustment ratio; and,
use the adjustment ratio to determine the sufficient number of packets.

16. The apparatus of claim 11, wherein to adapt all connections with degraded link quality, the memory is further configured to allow the processor to:
determine a throughput requirement and a PHY mode of a connection with degraded link quality;
reduce the connection to a new PHY mode; and,
allocate a sufficient number of packets to satisfy the throughput requirement for the connection.

17. The apparatus of claim 16, where the PHY mode of the connection with degraded link quality and the new PHY mode both have a corresponding transmission rate and wherein to allocate the sufficient number of packets, the memory is further configured to allow the processor to:
divide, (i) the transmission rate of the PHY mode of the connection with degraded link quality, by, (ii) the transmission rate of the new PHY mode, to create an adjustment ratio; and,
use the adjustment ratio to determine the sufficient number of packets.

18. The apparatus of claim 12, where the capacity threshold is within a range of 80 to 100 percent.

19. An apparatus for maintaining quality of service (QoS) between an central controller and a set of mobile terminals (MTs) located within the coverage area of a basic service set (BSS) in a wireless local area network (WLAN), comprising:
means for detecting a connection request by an MT;
means for determining if adequate resources are available;
means for attempting to allocate additional resources, if adequate resources are not available; and,
means for establishing a connection with the MT using the most robust physical layer (PHY) mode with a sufficiently large set of packets to fulfill throughput requirements, if one of adequate resources are available and additional resources can be allocated.

20. The apparatus of claim 19, further comprising:
means for determining if a link quality of any connection has degraded; and,
means for adapting all connections with degraded link quality.

21. The apparatus of claim 19, wherein the means for determining if adequate resources are available comprises means for determining whether utilization of the BSS is below a capacity threshold.

22. The apparatus of claim 19, wherein the means for allocating additional resources comprises:
means for determining if any connection are not adapted to a higher PHY mode; and,
means for adapting at least one connection to the higher PHY mode if there is at least one connection not at the higher PHY mode.

23. The apparatus of claim 22, wherein the means for adapting at least one connection to the higher PHY mode if there is at least one connection not at the higher PHY mode comprises:
means for determining a throughput requirement and a PHY mode of the connection not at the higher PHY mode);
means for increasing the connection to a new PHY mode; and,
means for allocating a sufficient number of packets to satisfy the throughput requirement for the connection.

24. The apparatus of claim 23, where the PHY mode of the connection not at the higher PHY mode and the new PHY mode both have a corresponding transmission rate and wherein means for allocating the sufficient number of packets comprises:
means for dividing, (i) the transmission rate of the PHY mode of the connection not at the higher PHY mode, by, (ii) the transmission rate of the new PHY mode, to create an adjustment ratio; and,
means for using the adjustment ratio to determine the sufficient number of packets (712).

25. The apparatus of claim 20, wherein means for adapting all connections with degraded link quality comprises:
means for determining a throughput requirement and a PHY mode of a connection with degraded link quality;
means for reducing the connection to a new lower PHY mode; and,
means for allocating a sufficient number of packets to satisfy the throughput requirement for the connection.

26. The apparatus of claim 25, where the PHY mode of the connection with degraded link quality and the new PHY mode both have a corresponding transmission rate and wherein means for allocating the sufficient number of packets comprises:
means for dividing, (i) the transmission rate of the PHY mode of the connection with degraded link quality, by, (ii) the transmission rate of the new PHY mode, to create an adjustment ratio; and,
means for using the adjustment ratio to determine the sufficient number of packets.

27. The apparatus of claim 21, where the capacity threshold is within a range of 80 to 100 percent.

28. A method for providing reliable transmission for a critical packet in a connection comprising the steps of:
transmitting the critical packet at a first PHY mode;
determining if adequate resources in the connection are available; and, transmitting a duplicate packet on a second PHY mode if adequate resources are available.

29. The method of claim 28, where if it is determined that adequate resources are not available, then the method further comprises steps of:
determining if re-negotiation of the connection is possible; and,
re-negotiating the connection.

30. The method of claim 28, where the critical packet contains data that will become obsolete if retransmission is needed.

31. The method of claim 28, where the first PHY mode is higher than the second PHY mode.

32. The method of claim 28, where the step of determining if adequate resources in the connection are available comprises the steps of:
detecting available bandwidth in the channel; and,
determining if the available bandwidth is sufficient to transmit an amount of data equal to the amount of data in the critical packet.
